(19) United States
(12) Patent Application Publication
(10) Pub. No.: US 2025/0172383 A1
(43) Pub. Date: May 29, 2025

(54) TOPOGRAPHIC MEASURING DEVICE AND TOPOGRAPHIC MEASUREMENT METHOD

(71) Applicant: INSIDIX, Noyarey (FR)

(72) Inventors: Régis Braisaz, Réaumont (FR); Pierre Vernhes, Saint-Martin-D'uriage (FR)

(73) Assignee: INSIDIX, Noyarey (FR)

(21) Appl. No.: 18/964,082

(22) Filed: Nov. 29, 2024

(30) Foreign Application Priority Data
Nov. 28, 2023 (FR) 2313186

(51) Int. Cl. G01B 11/16; G06T 7/00

(52) U.S. Cl. CPC G01B 11/167; G06T 7/001; G06T 2207/30141

(57) ABSTRACT

A topographic measuring device comprises a sample-holder receiving a sample. A first projector applies a first textured light on a first part of the sample. A second projector applies a second textured light on a second part of the sample different from the first part. A first camera observes the first textured light applied on the first part to acquire first images. A second camera observes the second textured light applied on the second part to acquire second images. The second textured light has patterns with a second repetition pitch that is lower than a first repetition pitch of the patterns of the first textured light.

### BACKGROUND OF THE INVENTION

The invention relates to a topographic measuring device and to a topographic measurement method.

### PRIOR ART

In numerous technical fields related to printed circuits, different materials are associated with particular patterns to form electrical or electronic functions. These patterns result in the volume of a printed circuit not being homogeneous so that it deforms anisotropically with temperature and with time. It is also apparent that printed circuits generally have components that are salient from a main surface. These salient components must have a shape and size that are mastered as best as possible. For example purposes, the salient components are electrically conducting pads that will act as electric contact for an electronic chip or any other electronic device. Good dimensional mastery of the salient components ensures an efficient electric contact.

It is important to be able to measure the shape and dimensions of the multiple salient components as precisely and as quickly as possible. It is also important to know the general or particular deformation of a chip or a printed circuit in order to anticipate the causes of malfunctioning.

It is known to perform measurement of the dimensions of the salient components and of chip deformation by means of an optical method. A textured light is applied on the surface of a sample. The textured light defines a plurality of repetitive patterns that are applied on the surface of the sample.

Several images of the surface of the sample illuminated by the textured light are acquired. By analysing the different images, the dimensions and shape of the salient components and/or the three-dimensional deformation of the chip can be calculated.

The quality of measurement is greatly dependent on the quality of the images that were acquired and on the characteristics of the textured light. The textured light defines several areas having colour differences, typically black areas and white areas with preferentially a transition through grey levels. The distance between two black areas or two white areas imposes the resolution of the deformation measurement. The quality of measurement also depends on the resolution of the textured light, i.e. the distance between two white areas or two black areas. The resolution is limited by the technique for forming the textured light and also by physical limitations. As the studied surface is small, it is not possible to have a fringe density that is infinite.

In logical manner, the quality of measurement is a function of the optical performance of the camera, i.e. the resolution of the image acquired by the camera, which corresponds to the number of pixels per unit of length. For a given sample and for a given camera, a trade-off has to be found between the measurement definition able to be defined by the textured light and the measurement resolution of the camera. It is pointless providing a textured light with a very low repetition pitch if the latter is much lower than the resolution of the camera. On the contrary, a camera having a high resolution will be limited by the resolution of a textured light with a coarse pitch.

To keep the size and cost reasonable, it is not advantageous to have a camera with a large collection surface and a small definition pitch. It is also counter-productive to seek to have a textured light that is as fine as possible to measure coarse deformations of the sample. Depending on the type of deformation to be measured, the characteristics of the textured light and the resolution of the camera have to be made to match.

### OBJECT OF THE INVENTION

One object of the invention consists in providing a topographic measuring device that presents a better trade-off between its ability to measure a coarse deformation and its ability to measure a fine deformation.

This result tends to be achieved by means of a topographic measuring device comprising:
a sample-holder designed to receive a sample;
a first projector designed to apply a first textured light on at least a first part of the sample;
a second projector designed to apply a second textured light on at least a second part of the sample, the second part being different from the first part;
a first camera designed to observe the first textured light applied on the first part of the sample to acquire a first series of images;
a second camera designed to observe the second textured light applied on the second part of the sample to acquire a second series of images;
a control circuit connected to the first projector, to the second projector, to the first camera and to the second camera, the control circuit being configured so that the second textured light has patterns with a second repetition pitch that is lower than a first repetition pitch of the patterns of the first textured light.

In advantageous manner, the second part is adjacent to the first part.

In a particular configuration, the second part at least partially overlaps the first part.

In an advantageous development, the first part of the sample forms a ring around the second part of the sample.

Preferentially, the first projector defines a void area devoid of patterns. The second projector illuminates the void area without illuminating the patterns of the first textured light.

According to one embodiment, the control circuit is configured to acquire the images of the first series of images and of the second series of images simultaneously.

In an advantageous development, the control circuit is connected to at least one shutter configured to block transmission of the first textured light and of the second textured light alternately in the direction of the sample-holder in the second part to prevent superposition of the first textured light and the second textured light, or the control circuit is configured to emit the first textured light and the second textured light alternately.

Preferentially, the control circuit is configured to acquire at least one image of the second series of images between two images of the first series of images in a time period.

It is a further object of the invention to provide a method for performing topographic measurement of a sample that enables measurements of coarse deformation and of fine deformation to be made more easily.

This result tends to be achieved by means of a method for performing topographic measurement of a sample comprising the following steps:
arranging a sample on a sample-holder;
applying a temperature ramp on the sample;
applying a first textured light on a first part of the sample and a second textured light on a second part of the sample different from the first part of the sample, the second textured light having patterns with a second repetition pitch that is lower than a first repetition pitch of the patterns of the first textured light;
acquiring a first series of images of the first textured light applied on the first part of the sample during the temperature ramp;
acquiring a second series of images of the second textured light applied on the second part of the sample during the temperature ramp;
processing the first series of images and the second series of images to determine a first deformation of the first part and a second deformation of the second part during the temperature ramp.

In a preferential development, the second part is included in the first part. The first deformation is subtracted from the second deformation.

### BRIEF DESCRIPTION OF THE DRAWINGS

Other advantages and features will become more clearly apparent from the following description of particular embodiments and implementation modes of the invention given for non-restrictive example purposes only and represented in the accompanying drawings, in which:

FIG. 1 schematically illustrates an embodiment of a topographic measuring device according to the invention;

FIG. 2 schematically illustrates a top view of a sample subjected to two different textured lights;

FIG. 3 schematically illustrates a top view of a sample subjected to two different textured lights;

FIG. 4 schematically illustrates a top view of a sample subjected to the first textured light that is able to overlap second parts of the sample illustrated in a broken line;

FIG. 5 schematically illustrates a top view of a sample subjected to the first textured light that defines void areas delineating second parts of the sample illustrated in a broken line;

FIG. 6 schematically illustrates a top view of a sample subjected to the second textured light delineating second parts of the sample, the first part being illustrated in a broken line.

### DESCRIPTION OF THE EMBODIMENTS

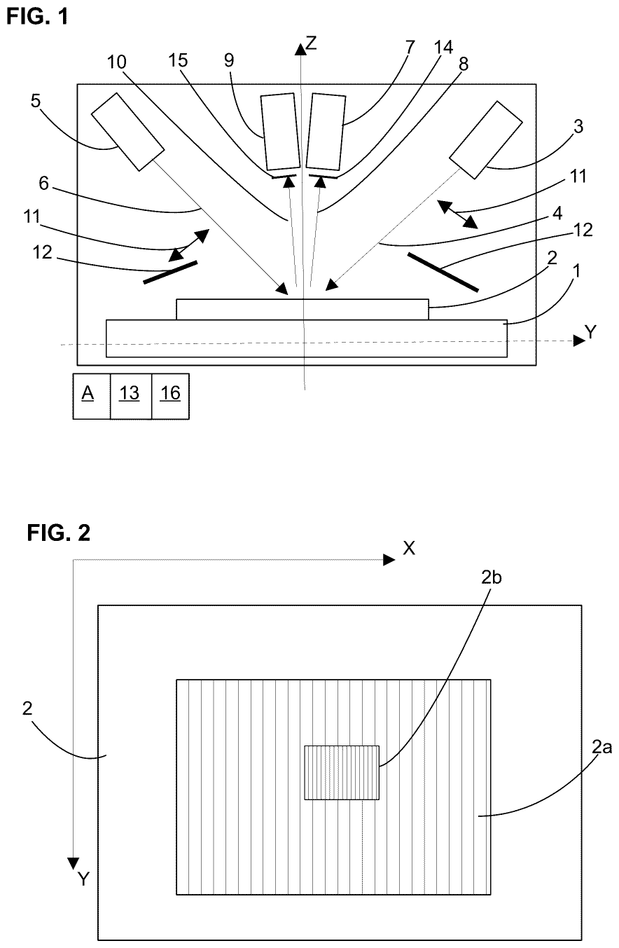

FIG. 1 illustrates a topographic measuring device having a sample-holder 1 designed to support a sample 2. The topographic measuring device also comprises a first projector 3 designed to apply a first textured light 4 on at least a first part 2a of the sample 2 and a second projector 5 designed to apply a second textured light 6 on at least a second part 2b of the sample 2. The second part 2b is different from the first part 2a.

The sample-holder 1 has a first face designed to receive the sample 2. The Z direction is normal to the first face.

Each of the first textured light 4 and the second textured light 6 defines several repetitive patterns for example several fringes. Illumination of the surface of the sample 2 is performed by the first projector 3 and the second projector 5. The textured light can be an image in shades of grey or in shades of other colours and possibly in black and white. The textured light defines patterns that are repeated with a predefined frequency and a predefined phase. The projectors are projection means that are configured to project a textured light preferably in the visible range.

The textured light advantageously forms a fringe pattern, for example of moiré or shadow moiré type. In one embodiment, the projector emits a fringe pattern directly. In an alternative embodiment, the textured light is formed by means of a mask through which the light coming from the projector passes. The mask comprises openings and opaques areas, for example in the form of a Ronchi ruling. It is also possible to combine these two techniques.

Predefined patterns are applied on the surface of the sample and the topography of the sample will modify the shape of the applied patterns. By analysing the changes of shape of the patterns, the three-dimensional deformation of the sample can be calculated.

The topographic measuring device comprises a first camera 7 designed to observe the first textured light 4 applied on the first part 2a of the sample 2 to acquire at least a first series of images 8 and a second camera 9 designed to observe the second the textured light 6 applied on the second part 2b of the sample 2 to acquire at least a second series of images 10. The second camera 9 is different from the first camera 7. As an alternative, the first camera 7 and the second camera 9 share the same detection sensor, but the image arrives via two different paths by means of lenses and/or prisms so as to observe two different portions of the sample 2 placed on the sample-holder 1.

The first camera 7 and the second camera 9 are image capture means configured to acquire series of images of the surface of the sample 2. The first camera 7 and the second camera 9 are arranged to capture the textured light applied on the surface of the sample 2. Preferentially, the optical axis of the first camera 7 and of the second camera 9 is parallel to the Z direction normal to the surface of the sample-holder 1 or presents a slight offset with respect to the Z direction.

Each camera acquires a series of images. The images of each series are compared to one another or to a reference to observe the deformations of the textured lights and to deduce the deformations of the sample 2 therefrom.

The images are sent to a computing circuit A configured to compute the deformations between the images and to compute the three-dimensional deformation of the sample 2.

The topographic measuring device comprises a control circuit 16 connected to the first projector 3, to the second projector 5, to the first camera 7 and to the second camera 9. The control circuit 16 is configured so that the second textured light 6 has patterns with a second repetition pitch that is lower than a first repetition pitch of the patterns of the first textured light 4. As the second textured light 6 has patterns with a second repetition pitch that is lower than a first repetition pitch of the patterns of the first textured light 4, the second textured light 6 enables finer deformations to be measured than the first textured light 4.

During deformation of the sample 2, the first camera 7 will acquire a series of images of the first part 2a of the sample 2 on which the first textured light 4 with the first repetition pitch is applied. To measure the relevant information, the resolution of the first camera 7 is adapted to the surface of the first part 2a and to the quantity of information provided by the first textured light 4. The larger the surface of the first part 2a, the larger the quantity of information to be processed. The smaller the repetition pitch of the first textured light 4, the greater the amount of information to be processed. The performances of the first camera 7 define the surface of the first part/repetition pitch couple of the first textured light 4. It is advantageous for the first camera 7 to have an adjustable magnification so as to adjust the performances of the measurement to meet requirements. In preferential manner, the first projector 3 is provided with a magnification means, for example a plurality of mobile lenses, configured to increase or reduce the magnification of the repetition pitch of the first textured light 4. Preferentially, the repetition pitch is adapted to match the extent of the surface of the first part 2a and/or the required measurement resolution. As an alternative, the first projector 3 is able to deliver different first textured lights 4 with different repetition pitches.

During deformation of the sample 2, the second camera 9 will acquire a series of images of the second part 2b of the sample 2 on which the second textured light 6 with the second repetition pitch is applied. The resolution of the second camera 9 is adapted to the definition provided by the second textured light 6 and to the size of the second part 2b to measure the relevant information. It is advantageous for the second camera 9 to have an adjustable magnification so as to adjust the performances of the measurement to meet requirements. In preferential manner, the second projector 5 is provided with a magnification means, for example a plurality of mobile lenses, configured to increase or reduce the magnification of the repetition pitch of the second textured light 6. Preferentially, the repetition pitch is adapted to match the extent of the surface of the second part 2b and/or the required measurement resolution. As an alternative, the second projector 5 is able to deliver different second textured lights 6 with different repetition pitches.

As the second repetition pitch is lower than the first repetition pitch, it is advantageous for the resolution of the second camera 9 to be greater than the resolution of the first camera 7. Preferentially, the magnification of the second camera 9 is greater than the magnification of the first camera 7, during deformation measurement, if the sensors of the two cameras have the same definition. For example, the first camera 7 and the second camera 9 are identical and the adjustment of the resolution of the images taken by the two cameras is defined by the magnification of the lens arranged up-line from the sensor along the optical path.

The topographic measuring device comprises heater 12 and/or cooler 13 connected to the control circuit 16. The heater 12 and/or the cooler 13 are arranged so as to heat or cool the sample 2 so that the sample 2 follows a predefined temperature profile. In preferential manner, the heater 12 comprises heating by infrared radiation. Advantageously, the cooler 13 comprises application of a fluid that flows in the sample-holder 1 or is in direct contact with the sample-holder 1. Depending on requirements, the fluid can be a gas or a liquid. The nature of the fluid depends on the minimum temperature of the sample-holder 1 that is to be reached.

The control circuit 16 applies a temperature ramp to the sample 2. During the temperature ramp, the temperature value of the sample 2 changes and the sample 2 is deformed. During the temperature ramp, the first textured light 4 is applied on the first part 2a of the sample 2 and the second textured light 6 is applied on the second part 2b of the sample 2. During the temperature ramp, the first series of images 8 and the second series of images 10 are acquired. The images of the first series of images 8 are used for example to measure the deformation of the first part 2a during the temperature ramp. The images of the second series of images 10 are used for example to measure the deformation of the second part 2b during the temperature ramp.

During the same temperature ramp, the second series of images 10 enables a finer measurement of the deformation to be made in the second part 2b than the deformation measurement in the first part 2a that is made by the first series of images 8. The two series of images are acquired during the same temperature ramp which enables the behaviour of the sample 2 to be better characterised in comparison with two measurements made in two successive temperature ramps as it prevents an ageing effect of the sample 2.

It is particularly advantageous to use the deformation data acquired for the first part 2a to calculate more precise deformation data for the second part 2b. For the deformation data relative to the first part 2a to be the most relevant to study the deformation of the second part 2b, it is preferable for the second part 2b to be as close as possible to the first part 2a. Advantageously, the second part 2b is adjacent to the first part 2a, i.e. the first part 2a has an interface with the second part 2b.

Advantageously, at least a portion of the second part 2b is included in the first part 2a. The first part 2a can be considered as a non-convex, non-self-intersecting polygon, for example a rectangle whose intersection with a smaller rectangle has been eliminated. The second part 2b intrudes inside the first part 2a. Depending on the configurations, the portion taken by the second part 2b is measured or not by means of the first textured light 4 and the first camera 7. Preferentially, at least 50% of the surface of the second part 2b is included in the surface of the first part 2a. More advantageously, the second part 2b is totally included in the first part 2a, i.e. the first part 2a forms a ring around the second part 2b.

Application of the first textured light 4 and application of the second textured light 6 on the first part 2a and on the second part 2b can be performed in different ways. In one particular case, the first textured light 4 and the second textured light 6 are applied simultaneously during the temperature ramp. This embodiment is advantageous when the first camera 7 and the second camera 9 respectively perform acquisition of the first series of images 8 and of the second series of images 10 simultaneously. Preferably, simultaneous means acquisition at the same time.

When the first part 2a and the second part 2b are slightly offset or have a single side as interface, it is possible to apply the two textured lights simply. When the first part 2a and the second part 2b overlap partially or totally, it is important for the first textured light 4 not to be superposed on the second textured light 6. The first textured light 4 will define a void area, i.e. an area without a pattern that is preferably a non-illuminated area. This void area corresponds totally or partially to the second part 2b.

The void area may originate from a part of the illumination device of the first projector 3 that is not activated or from a shutter 11 arranged between the first projector 3 and the sample 2 along the optical path. The void area preferentially corresponds as faithfully as possible to the second part 2b. The second textured light 6 is applied in the void area at least partly delineated by the first textured light 4. A shutter 11 can also be present along the optical path of the second projector 5 to form a void area, i.e. without illumination by the second projector 5. Activating and deactivating the shutter 11 enables the extent of the illuminated area to be modified. Preferentially, the shutter 11 associated with the first projector 3 operates independently from the shutter 11 of the second projector 5.

It is advantageous to use a void area that is a non-illuminated area to be able to take advantage of a wider range in definition of the patterns and in particular when the patterns are represented in black and white or with grey levels. As an alternative, the first textured light 4 and the second textured light 6 use different wavelengths, for example to define different colours, and are projected simultaneously on the whole of their respective area. The first camera 7 or the control circuit 16 selects the first textured light 4 by colorimetric analysis, or preferentially by a first optical filter 14.

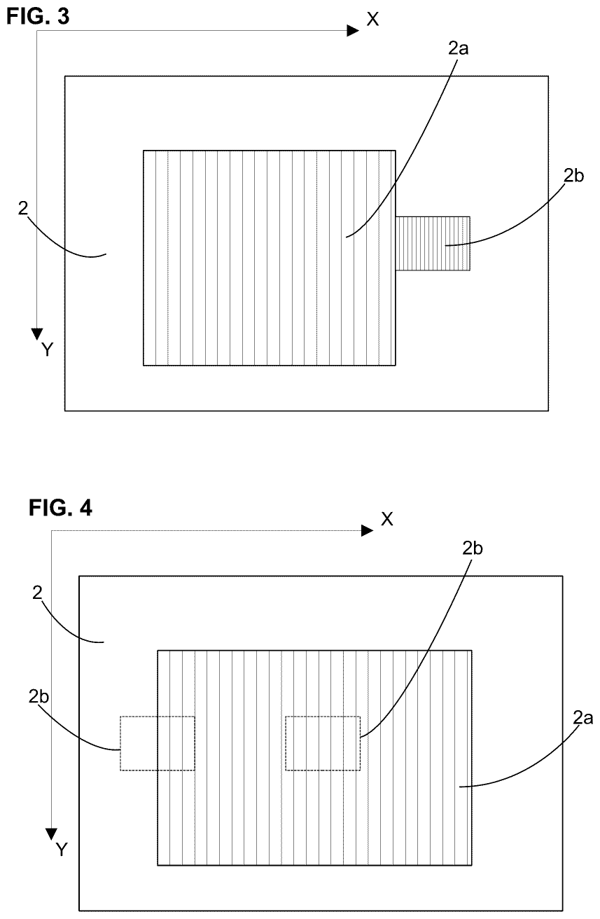

The second camera 9 selects the second textured light 6 by colorimetric analysis, or preferentially by a second optical filter 15. FIG. 2 illustrates an embodiment where the first part 2a completely surrounds the second part 2b and the two textured lights are applied simultaneously, the second part 2b being located inside a ring defined by the first part 2a. FIG. 3 illustrates an embodiment where the first part 2a and the second part 2b are adjacent and offset from one another. The interface appears in the form of a straight line.

In a preferential embodiment, the control circuit 16 is configured to simultaneously acquire the images of the first series of images 8 and of the second series of images 10 in a time period. The first textured light 4 is applied with a first wavelength and the second textured light 6 is applied with a second wavelength different from the first wavelength. The control circuit 16 separates the first textured light 4 and the second textured light 6 by colorimetric analysis or the first camera 7 and the second camera 9 are equipped with optical filters.

In an alternative embodiment illustrated in FIGS. 4, 5 and 6, the first textured light 4 is applied alternately with the second textured light 6 during the temperature ramp. This embodiment is advantageous when the second part 2b is at least partly included in the first part 2a.

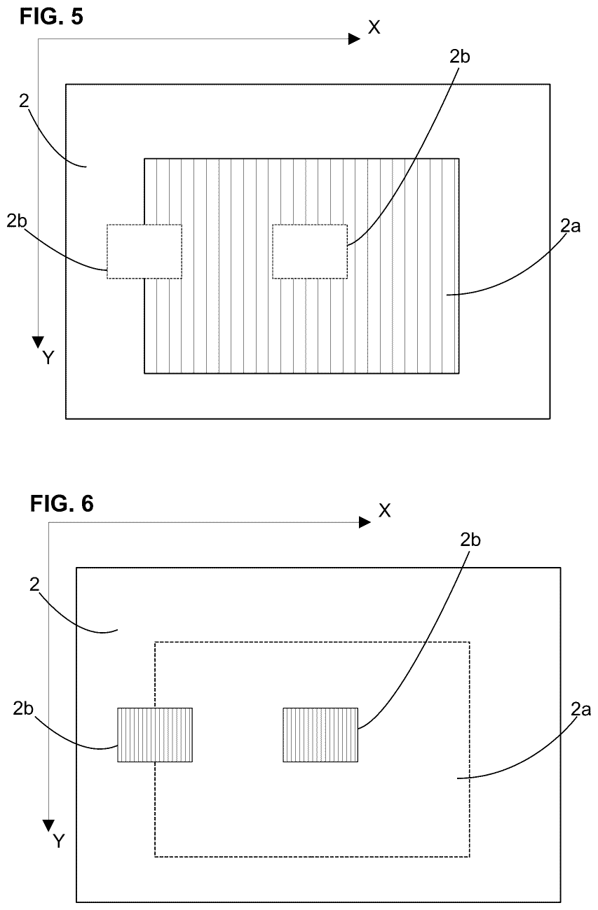

The first projector 3 and the second projector 5 can respectively apply the first textured light 4 and the second textured light 6 alternately on first part 2a and the second part 2b. FIGS. 4 and 5 illustrate application of the first textured light 4, the second part 2b being illustrated in a broken line. FIG. 6 illustrates application of the second textured light 6, the first part 2a being illustrated in a broken line.

As an alternative, at least one shutter 11 is connected to the control circuit 16 and is installed in movable manner to alternately block out the first textured light 4 and the second textured light 6 thereby illuminating the sample 2 alternately. The use of a shutter 11 is particularly advantageous as it can be moved quickly to block at least a part of the first textured light 4. This avoids having to switch the first projector 3 and/or the second projector 5 on and off regularly. The control circuit 16 can be configured so that any one portion of the sample 2 is not illuminated simultaneously by the first textured light 4 and the second textured light 6.

Alternative application of the first textured light 4 and the second textured light 6 when the first part 2a and the second part 2b overlap, and more preferentially overlap completely, enables two different deformations to be measured on the second part 2b.

The first series of images 8 enables the deformation of the first part 2a to be measured. The second series of images 10 enables the deformation of the second part 2b to be measured. When the second part 2b and the first part 2a overlap, it is advantageous to subtract the global deformation of the first part 2a from that measured for the second part 2b in order to determine the specific deformation of the second part 2b. When the first series of images corresponds to a measurement area that is larger than the second series of images and the first area surrounds the second area completely or overlaps on the second area over at least 50% of its surface, it is particularly advantageous to have a first series of images 8 that provides a lower resolution than the second series of images 10, for example at least 20% lower, in order to limit the quantity of information to be processed.

As an alternative to subtraction of the deformations, it is possible to compare the deformation of the second part 2b with the deformation of the first part 2a. If the difference between the deformations is less than a threshold value, the layer or layers of the second part 2b are compatible with the layer or layers of the first part 2a. For example, the second part 2b corresponds to all or part of a component arranged on a support. The first part 2a extends on the support. Comparison of the deformations makes it possible to detect whether the deformation of the component is compatible with the deformation of the support. As an alternative, the second part 2b extends in a hole of the support to detect whether the hole formed in the support modifies the deformation of the support. For example, the hole formed in the support means that two different stacks of layers are compared.

In another alternative, the first series of images 8 is analysed and an interpolated topography is calculated on the second part 2b from the measurement of the first part 2a. The interpolated deformation measurement of the first part 2a is then subtracted from the deformation measurement of the second part 2b to analyse only the deformations local to the second part 2b. When the second part 2b has a different stack from the first part 2a, interpolation makes it possible to estimate the deformation component corresponding to the stack of the first part 2a compared with the deformation calculated from the second series of images 10.

In preferential manner, the second part 2b is included in the first part 2a. The first deformation is subtracted from the second deformation or the first deformation and the second deformation are compared or an interpolated topography of the second part 2b calculated from the first deformation is subtracted from the first deformation to calculate the local deformations of the second part 2b.

The control circuit 16 comprises one or more processors and one or more memories designed to store information. The control circuit 16 can be included in a computer.

It is particularly advantageous for the images of first series of images 8 to be acquired simultaneously with the images of the second series of images 10, i.e. at the same time or almost the same time, so that two images are representative of the same state of deformation. The use of two projectors and two cameras makes for faster measurement compared with a single projector applying two different sets of textured lights and/or a camera performing two different acquisitions. By adapting the resolution of the image made by the camera to the resolution of the textured light pattern provided by the projector, the amount of relevant data delivered by the camera is enhanced. This avoids providing data that is not precise enough as the camera is under-performing as regards the textured light and also prevents the control circuit 16 from being saturated with useless data as the textured light has a too coarse pitch.

In a particular embodiment, the control circuit 16 controls the first camera 7 and the second camera 9 to acquire pairs of images corresponding to the same deformation states. The deformation states change with the temperature ramp. The control circuit 16 acts on the first projector 3 and the second projector 5 to deliver the textured lights during acquisitions, for example continuously.

In another embodiment, the control circuit 16 controls the first camera 7 and the second camera 9 to acquire images that represent different deformation states between the first camera 7 and the second camera 9. The control circuit 16 also controls the first camera 7 and the second camera 9 to acquire a single pair of images corresponding to the same deformation state, or several pairs of images corresponding to the same deformation states. The deformation states change with the temperature ramp.

In each series of images, the images are compared with each other or with a reference image to calculate the deformation of at least part of the sample. The pair or pairs of images acquired simultaneously are used as references to define one or more deformation states common to both series of images. This enables the deformation states to be compared with each other.

By acquired at the same deformation state, we mean that the images are acquired at the same or similar times. The time lag between image acquisitions can be a function of the sample measured or the temperature ramp applied. The difference between two images representing the same state of deformation may be a few seconds, for example 5 seconds or more. This difference makes it possible to acquire a large quantity of data without having to use computing resources capable of managing all this data at the same time.

Preferentially, the two projectors are installed movable with respect to the sample-holder 1. In one embodiment, the two projectors are installed movable in directions X and Y and the sample-holder 1 is installed immobile in these two directions. In another embodiment, the two projectors are installed immobile in directions X and Y and the sample-holder 1 is installed movable in these two directions. In a last embodiment, the two projectors are installed movable in directions X and Y and the sample-holder 1 is also installed movable in these two directions. The two projectors can be installed movable independently from one another in directions X and/or Y.

Directions X and Y are perpendicular to one another and perpendicular to direction Z.

It is also possible to provide for the first camera 7 and/or the second camera 9 to be installed movable with respect to the sample-holder 1 in directions X and Y.

As an alternative or as a complement, the control circuit 16 is also configured to move the first part 2a along the sample 2 during deformation to calculate the deformation of a surface at least twice as large as the surface of the first part 2a, preferentially to calculate the deformation of a surface larger than 80% of the surface of the sample 2. More preferentially, the control circuit 16 is configured so that the first projector 3 and the second projector 5 apply a first textured light 4 and a second textured light 6 that present the same repetition pitch. It is advantageous for the control circuit 16 to move the two projectors and the two cameras so that the first part 2a and the second part 2b move independently from one another in order to characterise at least 80% of the surface of the sample 2. By using two distinct couples of projectors and cameras, the surface of the sample 2 can be measured twice as quickly.

1. Topographic measuring device comprising:
a sample-holder designed to receive a sample;
a first projector designed to apply a first textured light on at least a first part of the sample;
a second projector designed to apply a second textured light on at least a second part of the sample, the second part being different from the first part;
a first camera designed to observe the first textured light applied on the first part of the sample to acquire a first series of images;
a second camera designed to observe the second textured light applied on the second part of the sample to acquire a second series of images;
heater and/or cooler configured to heat or cool the sample to deform the sample;
a control circuit connected to the first projector, to the second projector, to the first camera and to the second camera, the control circuit being configured so that the second textured light has patterns with a lower second repetition pitch than a first repetition pitch of patterns of the first textured light;
wherein the control circuit is connected to the heater and/or cooler to apply a temperature ramp to the sample;
wherein the control circuit compares the images of the first series of images with one another or to a reference to deduce a deformation of the first part therefrom and compares the images of the second series of images with one another or to a reference to deduce a deformation of the second part therefrom;
wherein during the temperature ramp, the first textured light is applied on the first part of the sample and the second textured light is applied on the second part of the sample and the first series of images and the second series of images are acquired;
wherein the second part is adjacent to the first part;
and wherein the control circuit is configured to acquire images of the first series of images and the second series of images in same deformation states during the ramp of temperature or to acquire images representative of different deformation states and at least one image of the first series of images and at least one image of the second series of images representative of the same state of deformation.

2. Topographic measuring device according to claim 1 wherein the second part at least partially overlaps the first part.

3. Topographic measuring device according to claim 2 wherein the first part of the sample forms a ring around the second part of the sample.

4. Topographic measuring device according to claim 3 wherein the first projector defines a void area devoid of patterns and wherein the second projector illuminates the void area without illuminating the patterns of the first textured light.

5. Topographic measuring device according to claim 1 wherein the control circuit is configured so that the first textured light and the second textured light are applied simultaneously and to acquire the images of the first series of images and of the second series of images simultaneously during the temperature ramp.

6. Topographic measuring device according to claim 5 wherein the first textured light is applied with a first wavelength and the second textured light is applied with a second wavelength different from the first wavelength and wherein the control circuit separates the first textured light and the second textured light by colorimetric analysis or the first camera and second camera are provided with optical filters.

7. Topographic measuring device according to claim 2 wherein the control circuit is connected to at least one shutter configured to alternately block transmission of the first textured light and of the second textured light in the direction of the sample-holder in the second part to prevent superposition of the first textured light and the second textured light or wherein the control circuit is configured to alternately emit the first textured light and the second textured light.

8. Topographic measuring device according to claim 7 wherein the control circuit is configured to acquire at least one image of the second series of images between two images of the first series of images in a time period.

9. Method for performing topographic measurement of a sample comprising the following steps:
arranging a sample on a sample-holder;
applying a temperature ramp on the sample;
applying a first textured light on a first part of the sample and a second textured light on a second part of the sample different from the first part of the sample, the second textured light having patterns with a lower second repetition pitch than a first repetition pitch of patterns of the first textured light;
acquiring a first series of images of the first textured light applied on the first part of the sample during the temperature ramp;
acquiring a second series of images of the second textured light applied on the second part of the sample during the temperature ramp;
processing the first series of images and the second series of images to determine a first deformation of the first part and a second deformation of the second part during the temperature ramp.

10. Method for performing topographic measurement of a sample according to claim 9 wherein the second part is included in the first part and wherein the first deformation is subtracted from the second deformation or wherein the first deformation and the second deformation are compared or wherein an interpolated topography of the second part calculated from the first deformation is subtracted from the first deformation to calculate local deformations of the second part.
